(19) United States
(12) Patent Application Publication
(10) Pub. No.: US 2001/0036286 A1
(43) Pub. Date: Nov. 1, 2001

(54) Soundfield playback from a single speaker system

(75) Inventors: Leonard Charles Layton, Marrickville (AU); David Stanley McGrath, Bondi (AU)

Correspondence Address: RICHARD P. BERG, c/o LADAS & PARRY, Suite 2100, 5670 Wilshire Boulevard, Los Angeles, CA, 90036-5679, US

(73) Assignee: Lake Technology Limited

(21) Appl. No.: 09/838,913

(22) Filed: Apr. 20, 2001

Related U.S. Application Data
(63) Continuation of application No. 09/285,497, filed on Mar. 31, 1999, now abandoned.

(30) Foreign Application Priority Data
Mar. 31, 1998 (AU) PP2726

(51) Int. Cl. H04R 5/02; H04R 1/02; H04R 9/06

(52) U.S. Cl. 381/304; 381/305; 381/335; 381/22

(57) ABSTRACT

An improved method and apparatus for recreating spatially natural soundfields in a variety of listening environments is disclosed. The apparatus includes a speaker cabinet that contains multiple drivers each driven so as to effect an overall radiation pattern that mimics the soundfield pattern described by a B-format signal vector. This apparatus allows natural or synthetic soundfields to be played back from a relatively small mechanical speaker structure, providing the benefits of multichannel sound without a cumbersome arrangement of individual speaker cabinets.

### FIELD OF THE INVENTION

The present invention relates to the field of sound projection.

### BACKGROUND OF THE INVENTION

Full surround sound signals are becoming more and more prevalent in society as a higher quality form of sound projection. For example, the Dolby 5 channel system is enormously popular in cinemas. Other formats, such as B-Format surround sound is also very popular.

Unfortunately, full surround sound capabilities may be difficult to implement in that they often require a complex predetermined arrangement of speakers to be set up. Alternative, less cumbersome arrangements are often desirable.

### SUMMARY OF THE INVENTION

In accordance with a first aspect of the present invention, there is provided an apparatus for playback of multi-channel sound signals having spatial characteristics, the apparatus comprising: a decoder for converting the multi-channel sound signals into a series of speaker outputs for virtual speakers placed in pre-determined positions around a listener; a single speaker cabinet; a multiplicity of speaker elements arranged around the cabinet, the speaker elements coupled with predetermined ones of the series of speaker outputs so as to project their acoustic output substantially in the radial direction that a virtual speaker would be placed around the cabinet if the cabinet were the listener.

The multi-channel sound signals can comprise B-format signals. In one embodiment, the speaker cabinet can be mounted centrally on a roof in a room.

In accordance with a further aspect of the present invention, there is provided a method for playback of multi-channel sound signals having spatial characteristics on a speaker arrangement, the method comprising the steps of: (a) decoding the signals for a set of virtual speakers placed around a listener so as to produce a set of decoded speaker signals; and (b) projecting the set of decoded speaker signals from a series of closely clustered speakers with each of the decoded speaker signals being projected in a direction of a corresponding virtual speaker located around the cluster.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates schematically the arrangement of the preferred embodiment; and

FIG. 2 illustrates an example B-format to speaker output arrangement.

### DESCRIPTION OF PREFERRED AND OTHER EMBODIMENTS

In discussion of the embodiments of the present invention, it is assumed that the input sound has a three dimensional characteristics and is in an “ambisonic B-format”. It should be noted however that the present invention is not limited thereto and can be readily extended to other formats such as SQ, QS, UMX, CD-4, Dolby MP, Dolby surround AC-3, Dolby Pro-logic, Lucas Film THX etc.

The ambisonic B-format system is a very high quality sound positioning system which operates by breaking down the directionality of the sound into spherical harmonic components termed W, X, Y and Z. The ambisonic system is then designed to utilise all output speakers to cooperatively recreate the original directional components.

For a description of the B-format system, reference is made to:

(1) The Internet ambisonic surround sound FAQ available at the following HTTP locations.

http://www.omg.unb.ca/-mleese/

http://www.york.ac.uk/inst/mustech/3d

audio/ambison.htm

http://jrusby.uoregon.edu/mustech.htm

The FAQ is also available via anonymous FTP from pacific.cs.unb.ca in a directory /pub/ambisonic. The FAQ is also periodically posted to the Usenet newsgroups mega.audio.tech, rec.audio.pro, rec.audio.misc, rec. audio. opinion.

(2) “General method of theory of auditory localisation”, by Michael A Gerzon, 90 sec, Audio Engineering Society Convention, Vienna Mar. 24-27, 1992.

(3) “Surround Sound Physco Acoustics”, M. A. Gerzon, Wireless World, December 1974, pages 483-486.

(4) U.S. Pat. Nos. 4,081,606 and 4,086,433.

Normally, in providing a speaker arrangement for the reproduction of complex binaral reproduction formats such as B-format, a complex arrangement of speakers is provided and a mapping from the B-format to the series of speakers is utilized.

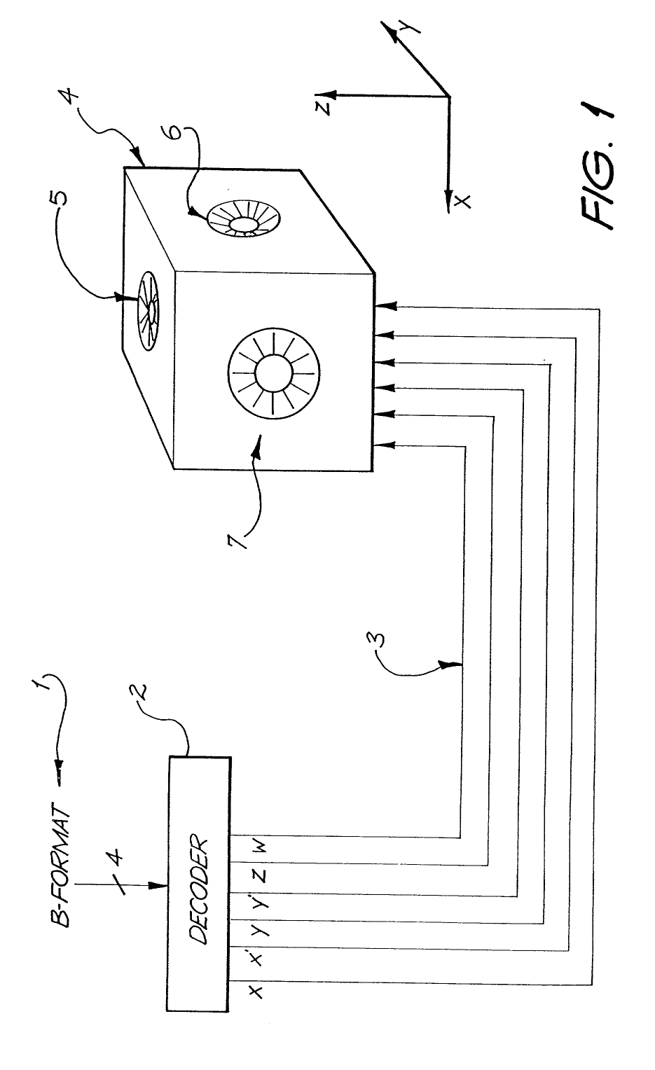

It has been found generally in the simulation of B-format outputs that alternative speaker arrangements often provide suitable ‘localization’ of sounds. In a first embodiment, the arrangement of FIG. 1 was found to be suitable where a single speaker box having a number of speakers is provided for the playing of B-format input.

The B-format input 1 is decoded in the normal manner 2 so as to from a series of speaker outputs 6. the speaker outputs are then fed to a speaker box 4 having a number of speakers e.g. 5-7. The speakers were arranged to project sound in the opposite direction to that which would normally be required.

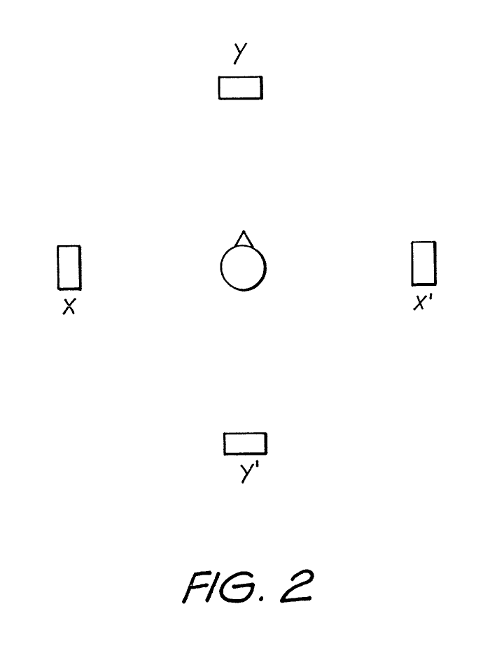

For example, assuming the decoder 2 is adapted to decode the B-format signals for a set of speakers arranged around a listener as illustrated in FIG. 2 (with a Z component being overhead). The output from the decoder 2 of FIG. 1 are then forwarded to the speaker box 4 and used to project sound from corresponding speakers with speaker 5 outputting the z and W components, speaker 6 outputting the X′ component, speaker 7 outputting the Y′ component and the remaining speakers outputting the X and Y components.

Of course, many minor modifications of the arrangement of FIG. 1 are possible. For example the speaker box 4 could be mounted on a roof of a large room and each side panel can contain a number of speakers having different frequency responses so as to provide for a flatter overall response.

It would be further appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

We claim:

1. An apparatus for playback of multi-channel sound signals having spatial characteristics, said apparatus comprising:
a decoder for converting said multi-channel sound signals into a series of speaker outputs for virtual speakers placed in pre-determined positions around a listener;
a single speaker cabinet;
a multiplicity of speaker elements arranged around said cabinet, said speaker elements coupled with predetermined ones of said series of speaker outputs so as to project their acoustic output substantially in the radial direction that a virtual speaker would be placed around said cabinet if said cabinet were said listener.

2. An apparatus as claimed in claim 1 wherein said multi-channel sound signals comprise B-format signals.

3. An apparatus as claimed in claim 1 wherein said speaker cabinet is mounted centrally on a roof in a room.

4. A method for playback of multi-channel sound signals having spatial characteristics on a speaker arrangement, said method comprising the steps of:
(a) decoding said signals for a set of virtual speakers placed around a listener so as to produce a set of decoded speaker signals; and
(b) projecting said set of decoded speaker signals from a series of closely clustered speakers with each of said decoded speaker signals being projected in a direction of a corresponding virtual speaker located around said cluster.

5. A method as claimed in claim 4 wherein said multi-channel sound signals comprise B-format signals.
